(19) United States
(12) Patent Application Publication
(10) Pub. No.: US 2012/0137847 A1
(43) Pub. Date: Jun. 7, 2012

(54) CUTTING APPARATUS

(75) Inventor: Xiaoming Qiu, Ota-Ku (JP)

(73) Assignee: DISCO CORPORATION, Tokyo (JP)

(21) Appl. No.: 13/298,843

(22) Filed: Nov. 17, 2011

(30) Foreign Application Priority Data
Dec. 2, 2010 (JP) 2010-269444

(51) Int. Cl. B26F 3/00

(52) U.S. Cl. 83/177

(57) ABSTRACT

A cutting apparatus including a chuck table for holding a workpiece, a cutting unit having a cutting blade for cutting the workpiece held on the chuck table, a cutting water supplying unit for supplying a cutting water to a work portion to be cut by the cutting blade, a pair of vibrating plates provided on the opposite sides of the cutting blade in such a manner that a spacing for forming a cutting water layer is defined between the upper surface of the workpiece held on the chuck table and the lower surface of each vibrating plate, and an ultrasonic vibrator for giving ultrasonic vibration to the vibrating plates.

### BACKGROUND OF THE INVENTION

1. Field of the Invention

The present invention relates to a cutting apparatus for cutting a workpiece such as a semiconductor wafer.

2. Description of the Related Art

In a semiconductor device fabrication process, a plurality of crossing division lines called streets are formed on the front side of a substantially disk-shaped semiconductor wafer to thereby partition a plurality of regions where devices such as ICs and LSIs are respectively formed. The semiconductor wafer is cut along the streets to thereby divide the regions where the devices are formed from each other, thus obtaining the individual semiconductor devices. Further, an optical device wafer is provided by forming a layer of gallium nitride compound semiconductors or the like on the front side of a sapphire substrate. The optical device wafer is also cut along the streets to obtain individual optical devices such as light emitting diodes and laser diodes, which are widely used in electric equipment.

Cutting of the semiconductor wafer and the optical device wafer along the streets is usually performed by using a cutting apparatus called a dicing saw. This cutting apparatus includes a chuck table for holding a workpiece such as a semiconductor wafer, cutting means having a cutting blade for cutting the workpiece held on the chuck table, feeding means for relatively moving the chuck table and the cutting means in a feeding direction, and indexing means for relatively moving the chuck table and the cutting means in an indexing direction perpendicular to the feeding direction. In such a cutting apparatus, the cutting operation is performed by rotating the cutting blade at a rotational speed of 20000 to 40000 rpm and supplying a cutting water to a work portion to be cut by the cutting blade, thereby preventing surface burning at a working point and chipping on the wall surface of each device.

The cutting water having contributed to the cutting contains chips and there is a problem such that the cutting water thus containing chips flows on the upper surface of the wafer and the chips adhere to the device surfaces as the wall surfaces of a cut groove formed by the cutting blade, causing contamination of the wafer. Particularly in the case of an optical device designed to incorporate light, such as a CCD, even slight contamination causes a remarkable reduction in quality. Further, although the cutting water is sufficiently supplied, there arises a problem such that the cutting blade may be jammed to cause chipping on the wall surfaces of the cut groove.

Japanese Patent Laid-open No. Sho 62-9914 discloses a method of cutting a wafer by using a cutting blade as supplying an ultrasonically vibrated pure water to the upper surface of a wafer to prevent the adhesion of chips to the device surfaces as the wall surfaces of the cut groove formed by the cutting blade.

### SUMMARY OF THE INVENTION

However, the cutting method described in Japanese Patent Laid-open No. Sho 62-9914 is not always satisfactory because the ultrasonically vibrated pure water is supplied and accordingly the fluidity of the cutting water having entered the cut groove formed by the cutting blade is insufficient.

It is therefore an object of the present invention to provide a cutting apparatus which can improve the fluidity of the cutting water supplied to the work portion to be cut by the cutting blade, thereby cutting a workpiece such as a wafer without the adhesion of chips to the cut surfaces and the upper surface of the workpiece.

In accordance with an aspect of the present invention, there is provided a cutting apparatus including a chuck table for holding a workpiece; cutting means having a cutting blade for cutting the workpiece held on the chuck table; cutting water supplying means for supplying a cutting water to a work portion to be cut by the cutting blade; a pair of vibrating plates provided on the opposite sides of the cutting blade in such a manner that a spacing for forming a cutting water layer is defined between the upper surface of the workpiece held on the chuck table and the lower surface of each vibrating plate; and an ultrasonic vibrator for giving ultrasonic vibration to the vibrating plates.

The cutting apparatus according to the present invention includes ultrasonic generating means having the pair of vibrating plates provided on the opposite sides of the cutting blade in such a manner that the spacing for forming the cutting water layer is defined between the upper surface of the workpiece held on the chuck table and the lower surface of each vibrating plate and also having the ultrasonic vibrator for giving ultrasonic vibration to the vibrating plates. When the ultrasonic generating means is operated, the vibrating plates are ultrasonically vibrated to thereby ultrasonically vibrate the cutting water layer formed between the upper surface of the workpiece and the lower surface of each vibrating plate. This ultrasonic vibration is propagated to the cutting water supplied to the work portion to be cut by the cutting blade. As a result, the fluidity of the cutting water having entered a cut groove formed by the cutting blade can be improved to thereby suppress the adhesion of chips to the wall surfaces of the cut groove and also prevent the adhesion of chips to the upper surface of the workpiece. Furthermore, since the fluidity of the cutting water having entered the cut groove formed by the cutting blade can be improved, the jamming of the cutting blade can be suppressed to thereby reduce the chipping occurring on the wall surfaces of the cut groove.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a cutting apparatus according to the present invention;

FIG. 2 is an exploded perspective view of an essential part of cutting means and cutting water supplying means included in the cutting apparatus shown in FIG. 1;

FIG. 3 is an elevational view showing the positional relation between a cutting blade constituting the cutting means, first and second nozzles constituting the cutting water supplying means, and ultrasonic generating means included in the cutting apparatus shown in FIG. 1;

FIGS. 4A and 4B are side views for illustrating a cutting step to be performed by the cutting apparatus shown in FIG. 1;

FIG. 5 is an elevational view similar to FIG. 3, illustrating the supply of a cutting water from the first and second nozzles in the cutting step shown in FIGS. 4A and 4B; and

FIG. 6 is an elevational view showing another preferred embodiment of the ultrasonic generating means in the cutting apparatus shown in FIG. 1 and illustrating the supply of a cutting water from the first and second nozzles.

### DETAILED DESCRIPTION OF THE PREFERRED EMBODIMENTS

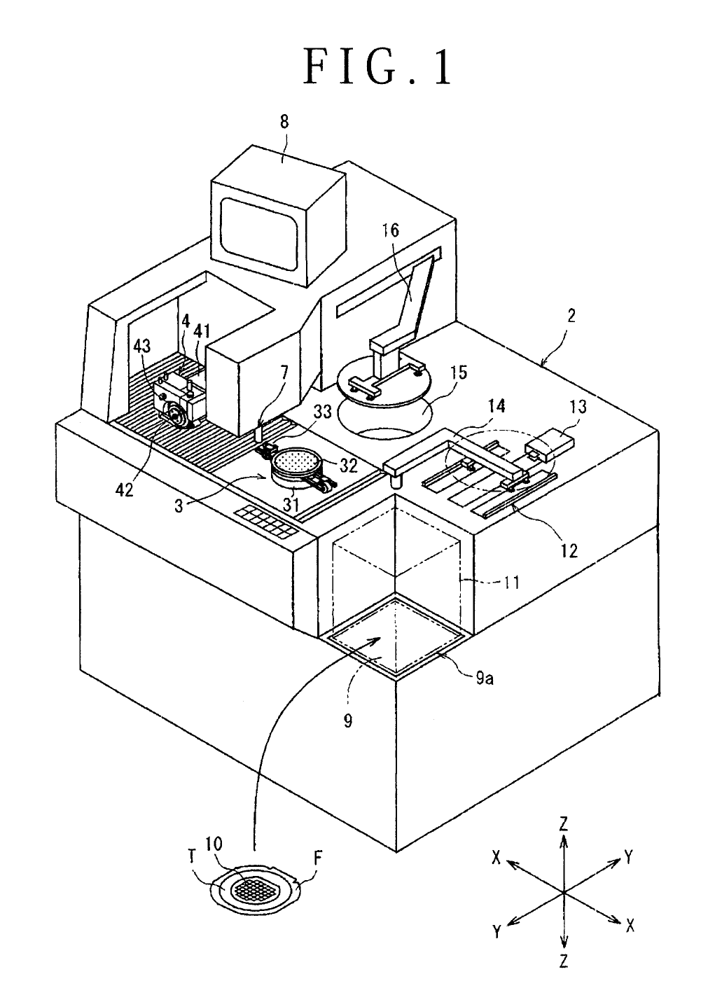

A preferred embodiment of the cutting apparatus according to the present invention will now be described in detail with reference to the attached drawings. Referring to FIG. 1, there is shown a perspective view of a cutting apparatus according to the present invention. The cutting apparatus shown in FIG. 1 has a substantially boxlike housing 2. The housing 2 contains a chuck table 3 for holding a workpiece. The chuck table 3 is movable in the direction shown by an arrow X as a feeding direction (X direction). The chuck table 3 has a vacuum chuck support 31 and a vacuum chuck 32 provided on the vacuum chuck support 31. The vacuum chuck 32 has an upper surface as a holding surface for holding the workpiece thereon under suction by operating suction means (not shown). Further, the chuck table 3 is rotatable by a rotating mechanism (not shown). The chuck table 3 is provided with a pair of clamps 33 for fixing an annular frame supporting a wafer as the workpiece through a dicing tape to be hereinafter described. Although not shown, the cutting apparatus includes feeding means for feeding the chuck table 3 in the X direction.

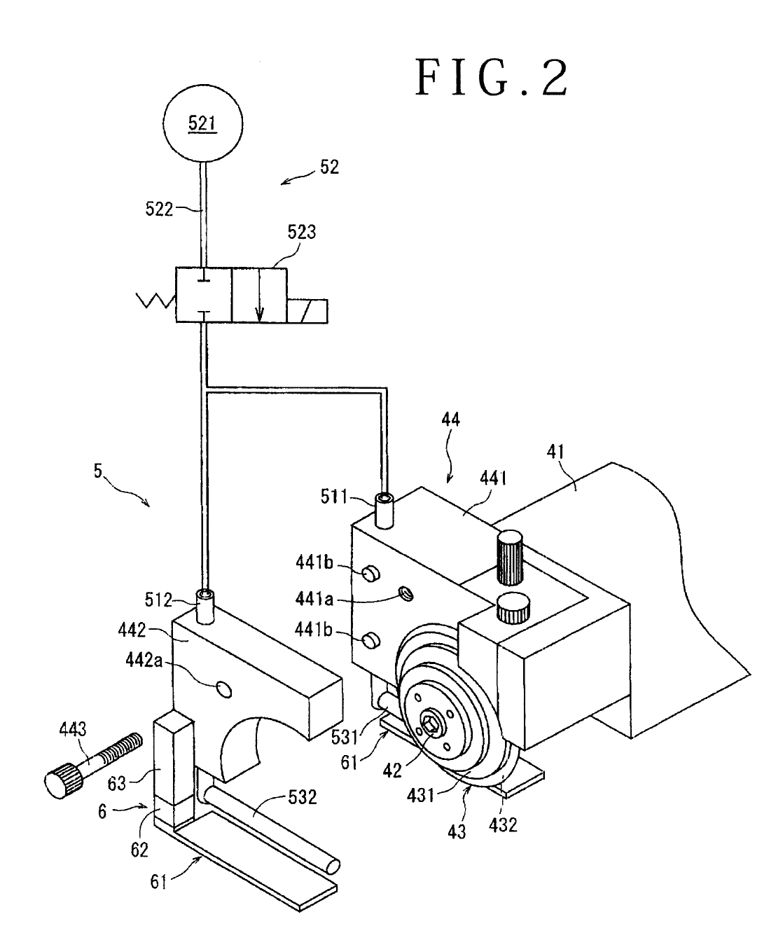

The cutting apparatus shown in FIG. 1 includes a spindle unit 4 as cutting means. The spindle unit 4 extends in an indexing direction (Y direction) shown by an arrow Y perpendicular to the X direction. The spindle unit 4 is movable in the Y direction by indexing means (not shown) and also movable in a cutting direction (Z direction) shown by an arrow Z by vertically moving means (not shown). The spindle unit 4 includes a spindle housing 41 mounted on a moving base (not shown) so as to be movable both in the Y direction and in the Z direction, a rotating spindle 42 rotatably supported to the spindle housing 41, and a cutting blade 43 mounted on the front end portion of the rotating spindle 42. The rotating spindle 42 is rotated by a servo motor (not shown). As shown in FIG. 2, the cutting blade 43 is composed of a disk-shaped base 431 formed of aluminum and an annular cutting edge 432 mounted on one side surface of the base 431 along the outer circumference thereof. The cutting edge 432 is formed by bonding diamond abrasive grains with a nickel plating so as to have a thickness of 15 to 30 μm.

As shown in FIG. 2, a blade cover 44 is mounted on the front end of the spindle housing 41 so as to cover the upper half portion of the cutting blade 43. The blade cover 44 is composed of a first cover member 441 mounted on the spindle housing 41 and a second cover member 442 mounted on the first cover member 441. One side surface of the first cover member 441 is formed with a tapped hole 441a and two positioning pins 441b. On the other hand, the second cover member 442 is formed with a through hole 442a aligned to the tapped hole 441a, and one side surface of the second cover member 442 opposed to the first cover member 441 is formed with two recesses (not shown) for respectively engaging the two positioning pins 441b. Accordingly, the first cover member 441 and the second cover member 442 are positioned to each other by engaging the two recesses of the second cover member 442 with the two positioning pins 441b of the first cover member 441. In this condition, a fastening bolt 443 is inserted through the through hole 442a of the second cover member 442 and screwed into the tapped hole 441a of the first cover member 441, thereby mounting the second cover member 442 to the first cover member 441.

Referring again to FIG. 2, the cutting apparatus in this preferred embodiment includes cutting water supplying means 5 for supplying a cutting water to a work portion to be cut by the annular cutting edge 432 of the cutting blade 43. The cutting water supplying means 5 includes a first cutting water supply pipe 511 provided on the first cover member 441 of the blade cover 44, a second cutting water supply pipe 512 provided on the second cover member 442 of the blade cover 44, cutting water feeding means 52 for feeding the cutting water to the first cutting water supply pipe 511 and the second cutting water supply pipe 512, a first nozzle 531 connected to the first cutting water supply pipe 511, and a second nozzle 532 connected to the second cutting water supply pipe 512.

The first and second cutting water supply pipes 511 and 512 are provided on the first and second cover members 441 and 442 of the blade cover 44, respectively. The upper ends of the first and second cutting water supply pipes 511 and 512 are connected to the cutting water feeding means 52. The first and second nozzles 531 and 532 are connected to the lower ends of the first and second cutting water supply pipes 511 and 512, respectively. The cutting water feeding means 52 is composed of a cutting water source 521, a cutting water feed pipe 522 for connecting the cutting water source 521 to the cutting water supply pipes 511 and 512, and an electromagnetic on-off valve 523 provided in the cutting water feed pipe 522. When the electromagnetic on-off valve 523 is deenergized (OFF state) to be closed, the communication between the cutting water source 521 and the first and second cutting water supply pipes 511 and 512 is cut off, whereas when the electromagnetic on-off valve 523 is energized (ON state) to be opened, the cutting water source 521 comes into communication with the first and second cutting water supply pipes 511 and 512 through the cutting water feed pipe 522.

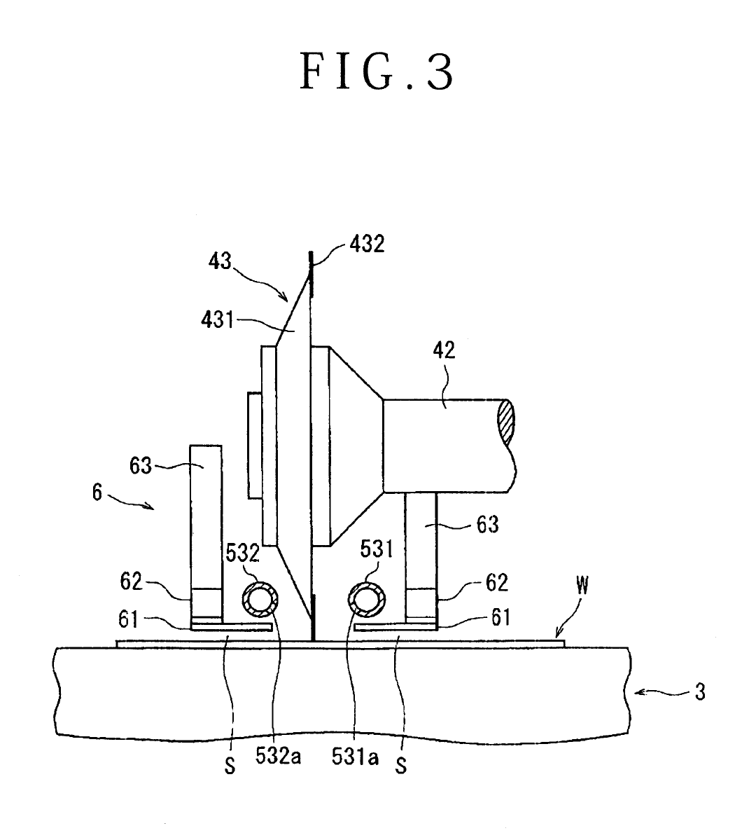

Each of the first and second nozzles 531 and 532 is formed from a pipe member. As shown in FIG. 3, the first and second nozzles 531 and 532 are located on the opposite sides of the annular cutting edge 432 of the cutting blade 43 so as to extend in the X direction perpendicular to the sheet plane of FIG. 3. The first and second nozzles 531 and 532 formed from pipe members are closed at their front ends. The first nozzle 531 is formed with a plurality of first nozzle holes 531a for spraying the cutting water toward the work portion to be cut by the annular cutting edge 432 of the cutting blade 43. Similarly, the second nozzle 532 is formed with a plurality of second nozzle holes 532a for spraying the cutting water toward the work portion to be cut by the annular cutting edge 432 of the cutting blade 43.

As shown in FIGS. 2 and 3, the cutting apparatus in this preferred embodiment includes ultrasonic generating means 6 for giving ultrasonic vibration to the cutting water supplied from the first and second nozzles 531 and 532 of the cutting water supplying means 5. The ultrasonic generating means 6 is composed of a pair of units respectively mounted on the first and second cover members 441 and 442. That is, the ultrasonic generating means 6 is composed of a pair of vibrating plates 61 provided on the opposite sides of the annular cutting edge 432 of the cutting blade 43, a pair of ultrasonic vibrators 62 for giving ultrasonic vibration to the vibrating plates 61, and a pair of mounting members 63 for respectively supporting the ultrasonic vibrators 62, these mounting members 63 being respectively mounted on the first and second cover members 441 and 442. Each of the two vibrating plates 61 is formed from a thin plate. The two vibrating plates 61 are located below the first and second nozzles 531 and 532, respectively, in such a manner that the lower surfaces of the vibrating plates 61 are parallel to the holding surface (upper surface) of the chuck table 3 and that a spacing S (1 to 2 mm) for forming a cutting water layer is defined between the lower surface of each vibrating plate 61 and the upper surface of a workpiece W held on the chuck table 3 as shown in FIG. 3. The lower surfaces of the ultrasonic vibrators 62 are bonded by an adhesive to the upper surfaces of the vibrating plates 61, and the upper surfaces of the ultrasonic vibrators 62 are bonded by an adhesive to the mounting members 63. The ultrasonic generating means 6 is connected to power supplying means (not shown) for supplying a high-frequency AC power to the ultrasonic vibrators 62.

Referring back to FIG. 1, the cutting apparatus in this preferred embodiment further includes imaging means 7 for imaging the front side (upper surface) of the workpiece held on the chuck table 3 to detect a region to be cut by the cutting blade 43. The imaging means 7 is provided by optical means including a microscope, CCD camera, etc. The cutting apparatus in this preferred embodiment further includes displaying means 8 for displaying an image obtained by the imaging means 7.

The housing 2 has a cassette setting area 9a, in which a cassette setting table 9 for setting a cassette 11 storing a semiconductor wafer 10 as the workpiece is provided. The cassette setting table 9 is vertically movable by elevating means (not shown). The cassette 11 storing the semiconductor wafer 10 is set on the cassette setting table 9. The front side of the semiconductor wafer 10 is partitioned into a plurality of rectangular regions by a plurality of crossing streets, wherein a plurality of devices such as ICs and LSIs are respectively formed in these plural rectangular regions. The semiconductor wafer 10 is stored in the cassette 11 in the condition where the back side (lower surface) of the semiconductor wafer 10 is attached to the upper surface (adhesive surface) of a dicing tape T supported to an annular frame F.

The cutting apparatus in this preferred embodiment further includes a temporary setting table 12 for temporarily setting the semiconductor wafer 10 supported through the dicing tape T to the annular frame F, handling means 13 for taking the semiconductor wafer 10 out of the cassette 11 set on the cassette setting table 9 to the temporary setting table 12, first transporting means 14 for transporting the semiconductor wafer 10 from the temporary setting table 12 to the chuck table 3, cleaning means 15 for cleaning the semiconductor wafer 10 after cutting the wafer 10 on the chuck table 3, and second transporting means 16 for transporting the semiconductor wafer 10 from the chuck table 3 to the cleaning means 15.

There will now be described a cutting operation for cutting the semiconductor wafer 10 along the streets by using the cutting apparatus mentioned above. The elevating means (not shown) is operated to vertically move the cassette setting table 9, thereby vertically moving the semiconductor wafer 10 stored at a predetermined position in the cassette 11 set on the cassette setting table 9 (in the condition where the semiconductor wafer 10 is supported through the dicing tape T to the annular frame F) to a loading position. Thereafter, the handling means 13 is linearly operated to transport the semiconductor wafer 10 from the loading position to the temporary setting table 12. The semiconductor wafer 10 is next transported from the temporary setting table 12 to the chuck table 3 by the swing operation of the first transporting means 14.

After the semiconductor wafer 10 is placed on the chuck table 3, the suction means (not shown) is operated to hold the semiconductor wafer 10 on the chuck table 3 under suction. Further, the annular frame F supporting the semiconductor wafer 10 through the dicing tape T is fixed by the clamps 33. Thereafter, the chuck table 3 holding the semiconductor wafer 10 under suction is moved to a position directly below the imaging means 7. When the chuck table 3 is positioned directly below the imaging means 7, the streets formed on the semiconductor wafer 10 are detected by the imaging means 7, and the spindle unit 4 is moved in the Y direction to accurately align the cutting blade 43 to a predetermined one of the streets extending in a first direction (alignment step).

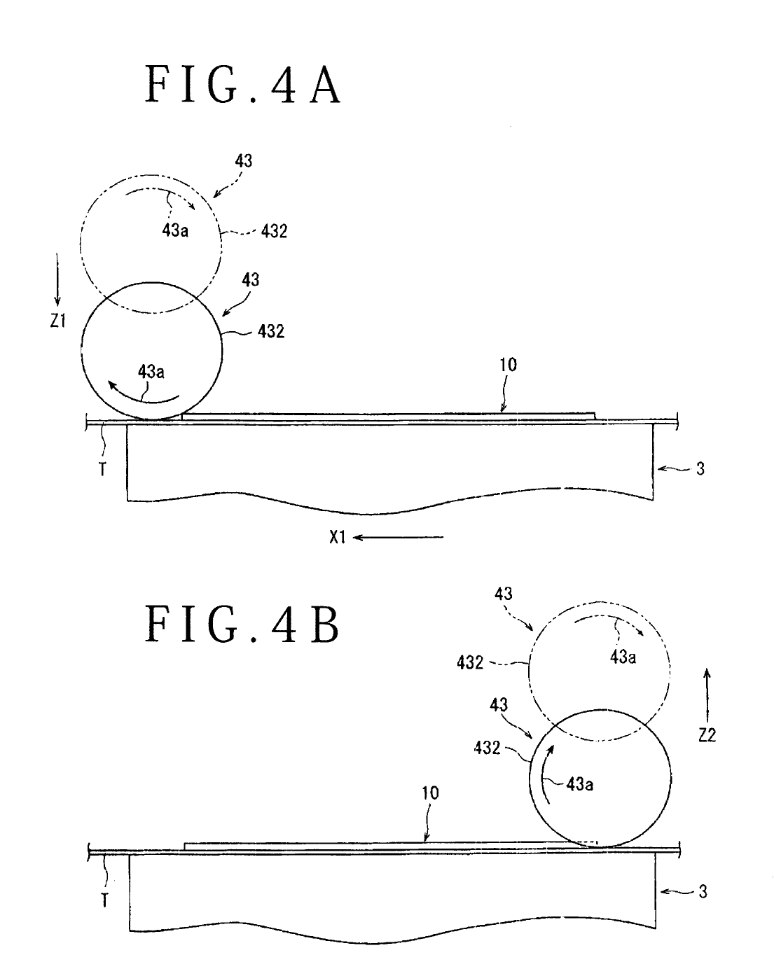

After performing the above alignment step, the chuck table 3 is moved to a cutting operation area below the cutting blade 43. In this cutting operation area, one end of the predetermined street mentioned above is positioned on the right side of the cutting blade 43 by a predetermined slight amount as shown in FIG. 4A. Thereafter, the cutting blade 43 is rotated in the direction shown by an arrow 43a in FIG. 4A. Simultaneously, the vertically moving means (not shown) is operated to lower the cutting blade 43 from a standby position shown by a chain double-dashed line in FIG. 4A to a working position shown by a solid line in FIG. 4A by a predetermined amount in the direction shown by an arrow Z1 in FIG. 4A. This predetermined amount is set so that the annular cutting edge 432 of the cutting blade 43 reaches the dicing tape T. Thereafter, the feeding means (not shown) is operated to move the chuck table 3 at a predetermined feed speed in the direction shown by an arrow X1 in FIG. 4A. When the other end of the predetermined street of the semiconductor wafer 10 held on the chuck table 3 reaches a position on the left side of the cutting blade 43 by a predetermined slight amount as shown in FIG. 4B, the movement of the chuck table 3 is stopped, and the cutting blade 43 is raised to the standby position shown by a chain double-dashed line in FIG. 4B in the direction shown by an arrow Z2 in FIG. 4B. As a result, the semiconductor wafer 10 is cut along the predetermined street (cutting step).

In performing the above cutting step, the electromagnetic on-off valve 523 of the cutting water feeding means 52 constituting the cutting water supplying means 5 is energized (ON state). Accordingly, the electromagnetic on-off valve 523 is opened as mentioned above to make the communication between the cutting water source 521 and the first and second cutting water supply pipes 511 and 512 through the cutting water feed pipe 522. As a result, the cutting water in the cutting water source 521 is fed through the cutting water feed pipe 522 and the first and second cutting water supply pipes 511 and 512 to the first and second nozzles 531 and 532. The cutting water supplied to the first and second nozzles 531 and 532 are sprayed from the first and second nozzle holes 531a and 532a.

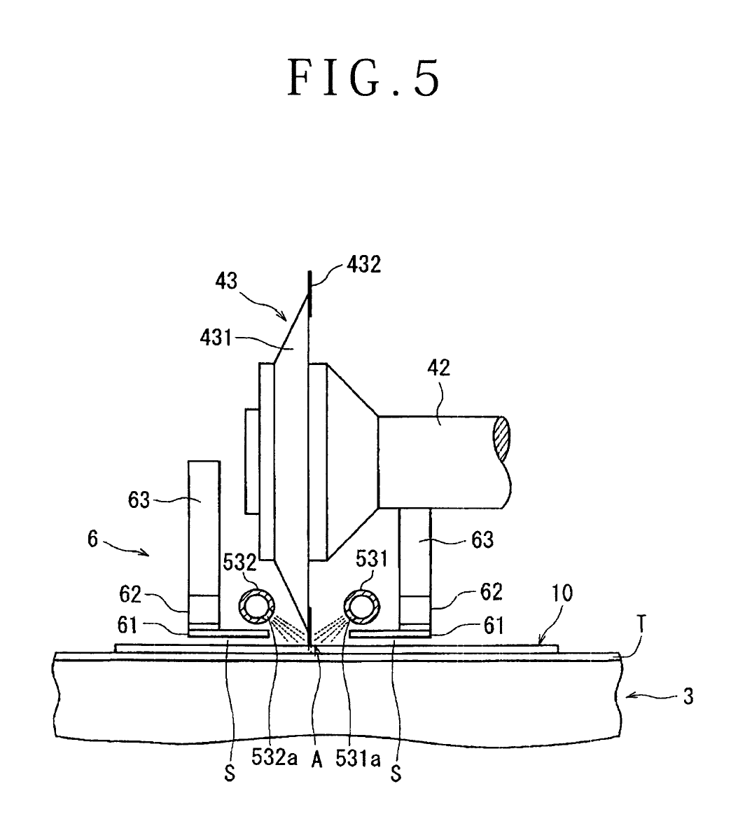

The cutting water sprayed from the first and second nozzle holes 531a and 532a of the first and second nozzles 531 and 532 is directed toward a work portion A to be cut by the annular cutting edge 432 of the cutting blade 43 as shown in FIG. 5. The cutting water sprayed to the work portion A flows on the semiconductor wafer 10 held on the chuck table 3 and forms a cutting water layer in the spacing S (1 to 2 mm) defined between the lower surface of each vibrating plate 61 of the ultrasonic generating means 6 and the upper surface of the semiconductor wafer 10. On the other hand, in performing this cutting step, a high-frequency AC power is applied from the power supplying means (not shown) to the ultrasonic vibrators 62 of the ultrasonic generating means 6. Accordingly, the ultrasonic vibrators 62 produce ultrasonic vibration, so that the vibrating plates 61 bonded to the ultrasonic vibrators 62 are ultrasonically vibrated in the vertical direction.

As a result, the cutting water layer formed in the spacing S between the semiconductor wafer 10 and each vibrating plate 61 is ultrasonically vibrated, and this ultrasonic vibration is propagated to the cutting water supplied to the work portion A to be cut by the annular cutting edge 432 of the cutting blade 43. Accordingly, not only the fluidity of the cutting water flowing on the upper surface of the semiconductor wafer 10, but also the fluidity of the cutting water having entered a cut groove formed by the annular cutting edge 432 of the cutting blade 43 can be improved, thereby suppressing the adhesion of chips to the wall surfaces of the cut groove (the side surface of each device) and the upper surface of each device. Further, since the fluidity of the cutting water having entered the cut groove formed by the annular cutting edge 432 of the cutting blade 43 can be improved as mentioned above, the jamming of the annular cutting edge 432 of the cutting blade 43 can be suppressed to thereby reduce the chipping occurring on the wall surfaces of the cut groove.

While the cutting water supplying means 5 in this preferred embodiment is so configured as to supply the cutting water to the work portion A from the first and second nozzles 531 and 532 located on the opposite sides of the annular cutting edge 432 of the cutting blade 43, the cutting water may be supplied from the upstream side in the moving direction of the chuck table 3 toward the spacing S between the upper surface of the semiconductor wafer 10 and the lower surface of each vibrating plate 61 and toward the work portion A.

After cutting the semiconductor wafer 10 along the predetermined street as mentioned above, the chuck table 3 is moved in the Y direction by the pitch of the streets to similarly perform the cutting step. After performing the cutting step along all of the streets extending in the first direction on the semiconductor wafer 10, the chuck table 3 is rotated 90° to similarly perform the cutting step along all of the other streets extending in a second direction perpendicular to the first direction. As a result, the semiconductor wafer 10 is cut along all of the crossing streets to divide the individual devices from each other. The individual devices thus divided from each other remain attached to the dicing tape T to maintain the form of the wafer 10 supported to the annular frame F.

After finishing the cutting step along the streets of the semiconductor wafer 10 as mentioned above, the chuck table 3 holding the semiconductor wafer 10 is returned to the original position where the semiconductor wafer 10 has first been held under suction. At this position, the suction holding of the semiconductor wafer 10 is canceled. The semiconductor wafer 10 is next transported to the cleaning means 15 by the second transporting means 16. The semiconductor wafer 10 is next cleaned and dried by the cleaning means 15. Thereafter, the semiconductor wafer 10 is transported to the temporary setting table 12 by the first transporting means 14. The semiconductor wafer 10 is finally stored into the cassette 11 at the predetermined position by the handling means 13.

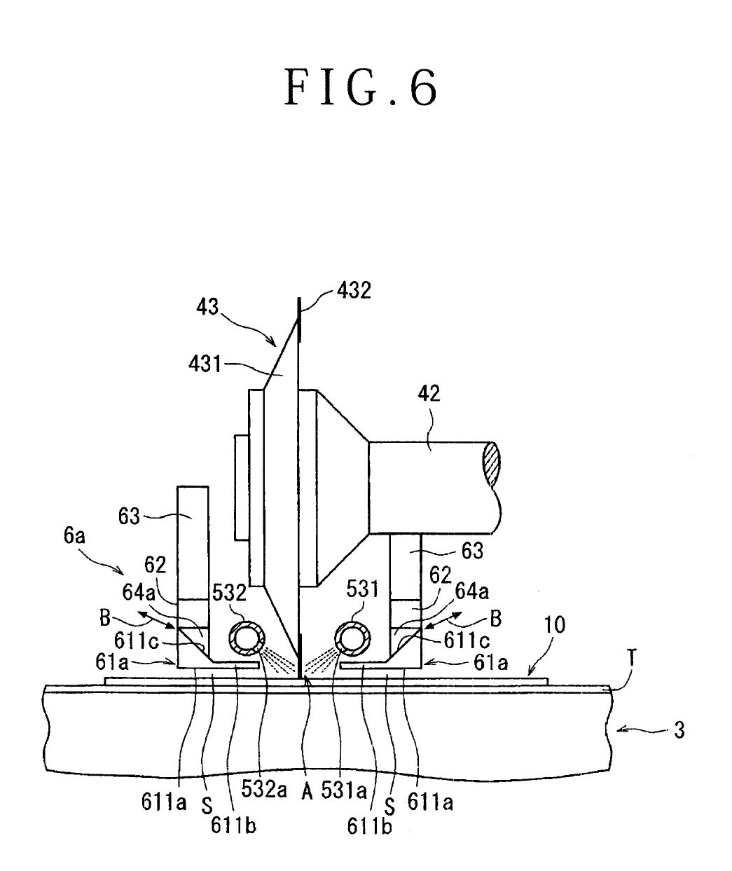

Another preferred embodiment of the ultrasonic generating means in the present invention will now be described with reference to FIG. 6. Referring to FIG. 6, there is shown ultrasonic generating means 6a substantially similar in configuration to the ultrasonic generating means 6 except the shape of the vibrating plates. In FIG. 6, the same parts as those of the ultrasonic generating means 6 shown in FIG. 5 are denoted by the same reference numerals and the detailed description thereof will be omitted herein. The ultrasonic generating means 6a shown in FIG. 6 is composed of a pair of vibrating plates 61a provided on the opposite sides of the annular cutting edge 432 of the cutting blade 43, a pair of ultrasonic vibrators 62 respectively mounted through a pair of connecting members 64a to the vibrating plates 61a, and a pair of mounting members 63 for respectively supporting the ultrasonic vibrators 62. Each of the vibrating plates 61a has a triangular cross section. The lower end portion of each vibrating plate 61a is formed with a thin plate portion 611b extending horizontally from a bottom surface 611a. The bottom surface 611a of each vibrating plate 61a is parallel to the holding surface (upper surface) of the chuck table 3. A spacing S for forming a cutting water layer is defined between the bottom surface 611a of each vibrating plate 61a and the upper surface of the semiconductor wafer 10 as the workpiece held on the chuck table 3 through the dicing tape T. Each vibrating plate 61a having a triangular cross section has an inclined surface 611c mounted through the corresponding connecting member 64a having a triangular cross section to the corresponding ultrasonic vibrator 62.

The ultrasonic vibrators 62 of the ultrasonic generating means 6a are connected to power supplying means (not shown) for supplying a high-frequency AC power. Accordingly, by applying the high-frequency AC power from the power supplying means (not shown) to the ultrasonic vibrators 62, ultrasonic vibration is produced in the ultrasonic vibrators 62. As a result, the vibrating plates 61a respectively connected through the connecting members 64a to the ultrasonic vibrators 62 can be ultrasonically vibrated in the directions shown by arrows B in FIG. 6. As a result, the cutting water layer formed in the spacing S between the semiconductor wafer 10 and each vibrating plate 61a is ultrasonically vibrated, and this ultrasonic vibration is propagated to the cutting water supplied to the work portion A to be cut by the annular cutting edge 432 of the cutting blade 43. Accordingly, the fluidity of the cutting water having entered the cut groove formed by the annular cutting edge 432 of the cutting blade 43 can also be improved to obtain an effect similar to that of the ultrasonic generating means 6.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A cutting apparatus comprising:
a chuck table for holding a workpiece;
cutting means having a cutting blade for cutting said workpiece held on said chuck table;
cutting water supplying means for supplying a cutting water to a work portion to be cut by said cutting blade;
a pair of vibrating plates provided on the opposite sides of said cutting blade in such a manner that a spacing for forming a cutting water layer is defined between the upper surface of said workpiece held on said chuck table and the lower surface of each vibrating plate; and
an ultrasonic vibrator for giving ultrasonic vibration to said vibrating plates.
